(19) United States
(12) Patent Application Publication
(10) Pub. No.: US 2020/0139695 A1
(43) Pub. Date: May 7, 2020

(54) SUPPLY STATION FOR OBJECT POST-PROCESSING

(71) Applicant: HEWLETT-PACKARD DEVELOPMENT COMPANY, L.P, Spring, TX (US)

(72) Inventors: Philip J. Stallbaumer, Vancouver, WA (US); Pierre J. Kaiser, Vancouver, WA (US)

(21) Appl. No.: 16/607,475

(22) PCT Filed: Mar. 7, 2018
(86) PCT No.: PCT/US18/21270

§ 371 Date: Oct. 23, 2019

(51) Int. Cl. B33Y 40/20; B33Y 30/00

(52) U.S. Cl. CPC B33Y 40/20; B33Y 10/00; B33Y 30/00

(57) ABSTRACT

According to one example, there is provided an apparatus comprising a supply station to receive a container, and a controller to determine when a build material container is present in the supply station and to cause the supply station to rotate the build material container to transfer build material between the build material container and a build material store, and determine when a post-processing container is inserted into the supply station and to cause the post-processing container to rotate to perform a post-processing operation on a three-dimensionally printed object in the post-processing container.

### BACKGROUND

Additive manufacturing, commonly referred to as three-dimensional or 3D printing, enables objects to be generated on a layer-by-layer basis, for example through the selective solidification of a build material.

Powder-based 3D printing systems, for example, typically form successive thin layers of a powder or particulate-type build material on a build platform within a build chamber and selectively solidify portions of each layer that represent a cross-section of a 3D object. The powdered build material may be stored in build material containers that may interface directly with an element of a 3D printing system.

### BRIEF DESCRIPTION

Examples will now be described, by way of non-limiting example only, with reference to the accompanying drawings, in which:

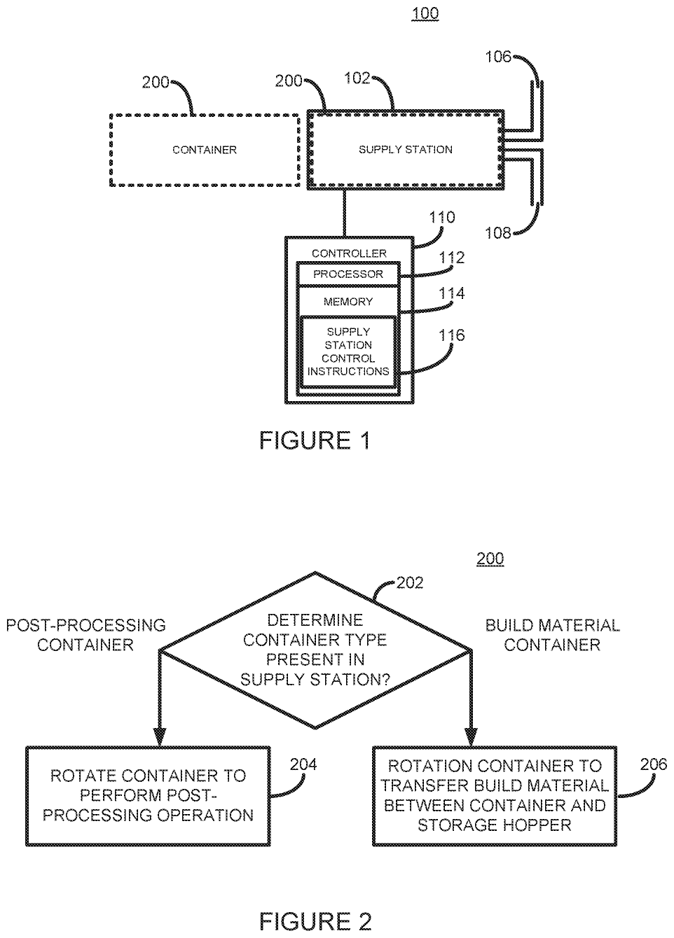

FIG. 1 is a block diagram of a supply station according to one example;

FIG. 2 is a flow diagram outlining an example method of operating a supply station;

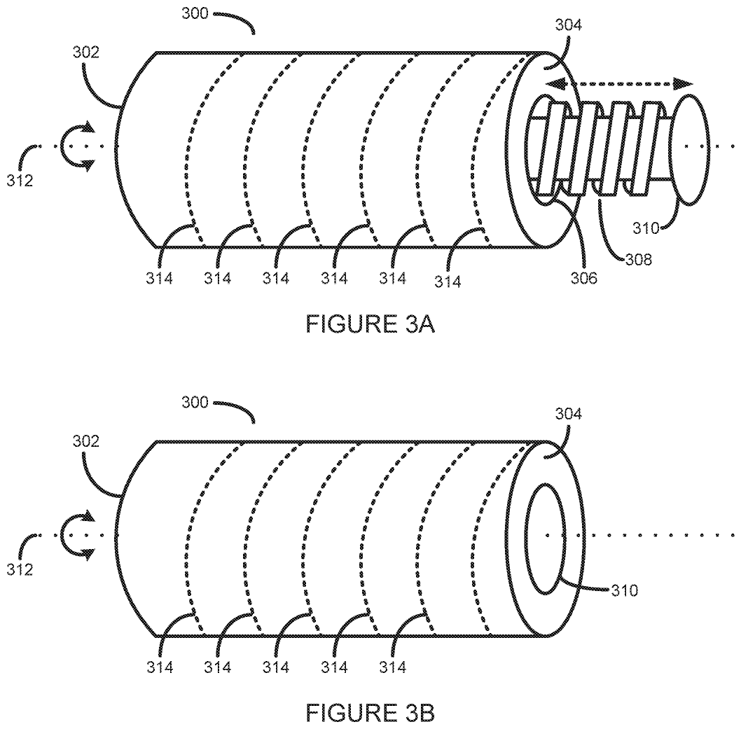

FIGS. 3A and 3B are illustrations of a build material container according to one example;

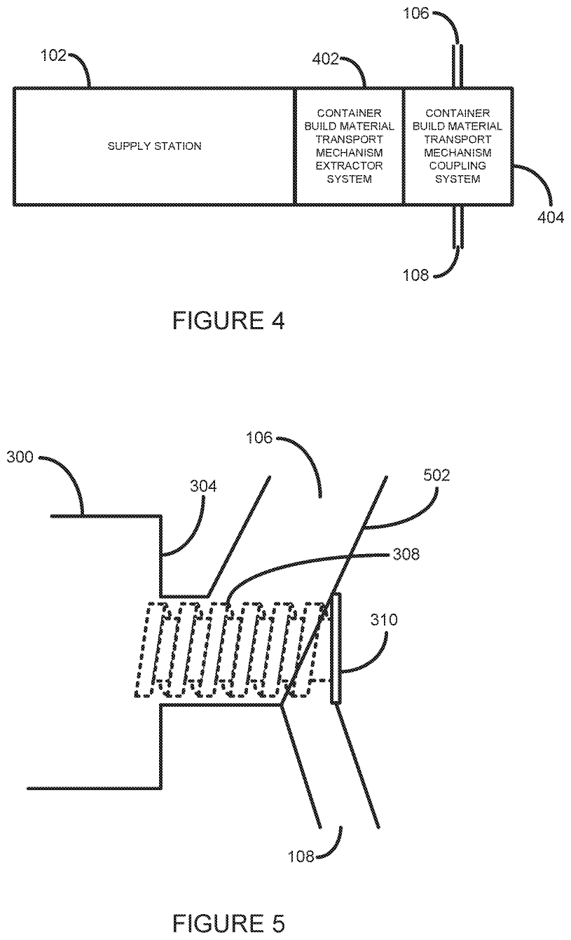

FIG. 4 is a block diagram of a supply station according to one example;

FIG. 5 is a schematic diagram of coupling mechanism according to one example;

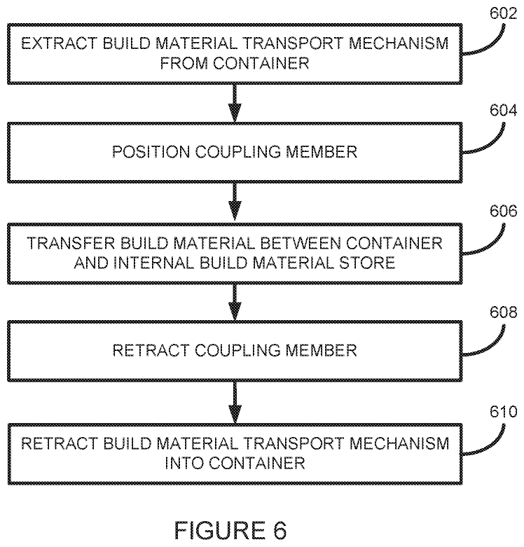

FIG. 6 is a flow diagram outlining an example method of transferring method from a build material container;

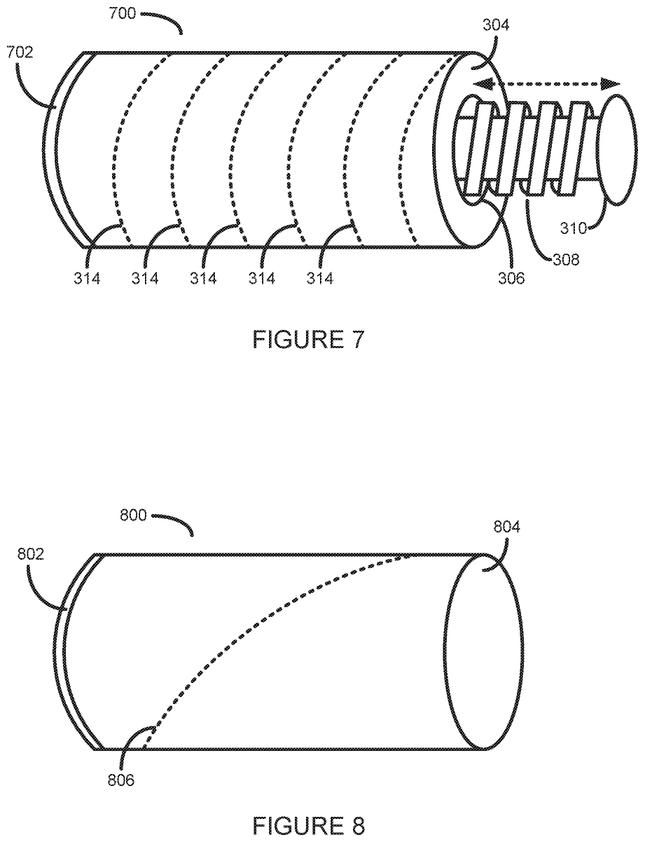

FIG. 7 is a schematic diagram of a post-processing container according to one example;

FIG. 8 is a schematic diagram of a post-processing container according to one example; and

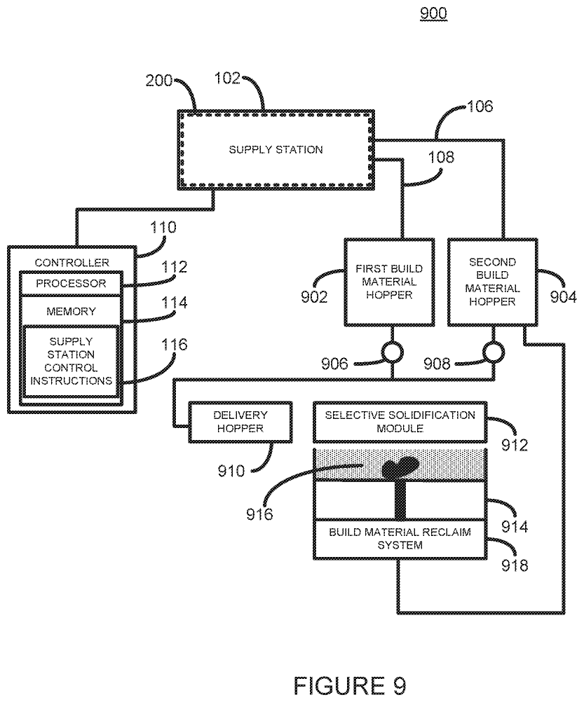

FIG. 9 is a block diagram of a 3D printing system according to one example.

### DETAILED DESCRIPTION

Referring now to FIG. 1, there is shown a block diagram of an apparatus 100 according to one example. In one example, the apparatus 100 is an element of a 3D printing system, such as a 3D printer. In another example the apparatus 100 is an element of a build material management station for use with a 3D printer.

The apparatus 100 comprises a supply station 102 into which a rotatable container 200, shown in dotted lines, may be removably inserted. In one example the container 200 may be a container that contains, or is to contain, a 3D printing build material (hereinafter referred to as a ‘build material container’). In one example the build material may be a particulate plastic powder, or powder-like, material, such as those used generally in 3D printing systems. Examples of suitable build material may include PA11, PA12, and other thermoplastics. In other examples other types of build material may be used, including: metal powder build material; and ceramic powder build material.

In another example, the container 200 may be a container into which a 3D printed object may be inserted to have a post-processing operation to be performed thereon (hereinafter referred to as a ‘post-processing container’).

The supply station 102 may determine a type of container present therein to determine an operation to be performed on the container. In one example, the determination may be made by a user via a user interface. In another example the container may comprise an identifier, such as an electronic or mechanical identifier, that enables the supply station 102 to determine, or to read, the type of container inserted thereinto.

The supply station 200 is to rotate a container 200, for example to rotate it about the container's central axis. In one example, the supply station may directly rotate the container 200, for example by having the container 200 seated on wheels and/or bearings, and providing a motorized drive mechanism to impart rotational motion to the container 200. In another example, the supply station 102 may comprise a rotatable cage or interface into which the container 200 may be inserted. In this example the cage may be rotated by a motorized drive mechanism.

In one example the supply station 102 further comprises a build material input port 106, through which build material may be supplied to be added to a build material container 200. In one example, the supply station 102 further comprises a build material output port 108 through which build material in a build material container 200 may be removed.

Build material may be supplied to the input 106 and may be removed from the exit 108 using any suitable build material transport system, such as a gravity feed system, a pneumatic conveyancing system, a mechanical feed screw system, or the like.

In one example the supply station 102 is designed to receive a container 200 in a substantially horizontal orientation. By substantially horizontal is meant the container rotation axis being at an angle of no more than about +/−10 degrees from horizontal. In another example, however, the supply station 102 may be designed to receive a container 200 at a higher angle from horizontal.

Operation of the apparatus 100 is controlled by a controller 110. The controller 110 comprises a processor 112, such as a microprocessor or microcontroller, coupled to a memory 114, for example via a suitable communications bus. The memory 114 stores processor understandable instructions 116 that, when executed by the processor 112, cause the processor 112 to control elements of the apparatus 100 as described herein.

Referring now to FIG. 2, there is shown a flow diagram outlining an example method 200 of operating the system 100 according to one example.

At block 202, the controller 110 determines whether a container present in the supply station 102 is a build material container or is a post-processing container.

At block 204, if the controller 110 has determined that the container present in the supply station 102 is a post-processing container, the controller 110 controls to the supply station 102 to rotate the container 200 to perform a post-processing operation on a 3D printed object present therein. A post-processing operation may be performed by rotating the container 200, for example, at a speed to cause a 3D printed object present in the container 200 to tumble as the container rotates.

This tumbling action may be used, for example, to clean an object, for example by helping remove non-fused powder that may be bound to the exterior of a 3D printed object upon its removal from a 3D printing build chamber. A tumbling action may also be used, for example, to modify a surface attribute of a 3D printed object, for example, by performing a smoothing action, a polishing action, a dying action, a roughing action, etc. The effect of the tumbling action or post-processing operation may be augmented, or made possible, by adding an amount of tumbling or post-processing media into the container 200 in which a 3D object is to be post-processed. Examples of tumbling media include: grit; sand; crushed walnut shells; powdered build material; and dye particles.

The post-processing operation may be further controlled by modifying other parameters, that may include: the speed of rotation of the post-processing container; the direction of rotation; the frequency of direction changes; and the duration of the rotation. The controller 110 may control the operation of a post-processing operation based on the type of post-processing operation to be performed.

At block 206, if the controller 110 has determined that the container present in the supply station 102 is a build material container, the controller 110 controls the supply station to either input build material into the build material container 200 via the input port 106, or to output build material from the build material container 200 via the output port 108.

Referring now to FIG. 3 there is shown an illustration of an example build material container 300 suitable for use in the supply station 102. The container 300 has a generally hollow cylindrical shape and comprises a closed end 302 and openable end 304 opposite the closed end 302. In other examples, however, the container 300 may have any other suitable shape. The container 300 provides an internal space, or reservoir, for storing build material, such as powdered build material suitable for use with a three-dimensional (3D) printing system. The openable end 304 comprises a aperture 306 in which is located an extendible and retractable build material transport mechanism 308. In the example shown the build material transport mechanism 308 comprises a screw mechanism. In one example the container has a length of about 60 cm, a height of about 20 cm, and a build material storage capacity of about 15 liters (15000 cm³). In other examples, however, containers with different dimensions and different storage capacities may be provided.

At the external extremity of the build material transport mechanism 308 is provided an end seal member 310. When the build material transport mechanism 308 is in the retracted position, as shown in FIG. 3B, the entirety of the build material transport mechanism is positioned within the outer housing of the container 300, wherein the end seal member 310 forms a substantial seal with the end 304 of the container 300. The end seal member 310 may fit flush to, or slightly protruding from, the end 304 of the container. The end seal member 310 may additionally comprise a protrusion, or other feature, (not shown) to allow extension and retraction of the build material transport mechanism 308. The seal provided by the seal member 310 is sufficient to prevent build material in the container 300 from unintentionally leaking out of the container when the build material transport mechanism 308 is in the retracted position. In one example a screw cap (not shown) may be fitted over the seal member 310 to securely hold the build material transport mechanism 308 in place in a sealed position, for example during transport of the container 300.

When in the extended position, as shown in FIG. 3A, the build material transport mechanism 308 is positioned such that a first portion of the build material transport mechanism 308 is located external to the outer housing of the container 300 and such that a second portion of the build material transport mechanism 308 is located internal to the outer housing of the container 300. The build material transport mechanism 308 and aperture 306 are axially aligned to a central rotation axis 312 of the container 300.

In one example the container 300 additionally comprises an internal build material transport system 314, shown in dotted lines, which may or may not be visible from the outside of the container depending on the container construction method. The transport system 314 may comprise, for example, one or multiple elements that form, for example, a continuous or a discontinuous screw thread, angled blades, or the like.

Where the build material transport mechanism 308 and the internal transport system 314 comprise screw mechanisms they both have the same handedness. The characteristics of the build material transport mechanism 308 and the internal transport system 314 affect the quantity of build material that is displaced for each revolution of the container. Such characteristics may include one or more of: the screw pitch; the root or minor diameter; the crest height or major diameter; the number of helices; and the thread angle.

As described in greater detail below, when the build material transport mechanism 308 is in its extended position, the container 300 may be rotated in a first direction about its central axis 312 to cause powdered build material stored in the container 300 to be removed from the container. Build material may thus be moved firstly by the internal transport system 314 towards the aperture 306, and secondly by the build material transport mechanism 308. In one example the container 300 may additionally comprise an internal scoop member (not shown), positioned towards the aperture 306, that acts to lift up an amount of build material within the container 300 and to deposit the amount of build material on the build material transport mechanism 308 as the container 300 is rotated in the first direction.

The container 300 may also be rotated in a second direction opposite the first direction to allow powdered build material to be added to the container 300. As the container 300 is rotated, build material supplied, for example, to at least a portion of the build material transport mechanism 308 is firstly transported towards the aperture 306 and then into the container 300, and is secondly transported generally towards the closed end 302 of the container 300 by the transport system 314. Due to the flowability of the build material, however, the effectiveness of the internal transport mechanism 314 may depend on the level of build material within the container. For example, the internal transport mechanism 314 may be most effective when the level of build material is close to or is below the height of features, such as a screw thread, of the internal transport mechanism.

FIG. 4 shows a schematic diagram of an example supply station, such as the supply station 102, in more detail. As illustrated, the supply station 102 additionally comprises a container build material transport mechanism extractor system 402 and a container build material transport mechanism coupling system 404, according to one example.

The container build material transport mechanism extractor system 402 provides a mechanism for extending and retracting the build material transport mechanism 308 of a container. In one example, the extractor system 402 comprises a movable mechanical arm to detachably connect to an extraction feature on the end seal member 310 such that movement of the mechanical arm may either retract or extend the build material transport mechanism 308. In one example, the extractor system 402 may be motorized and be controlled by the controller 110.

The container build material transport mechanism coupling system 404 provides a coupling member that is moveable over an extended build material transport mechanism 308 and is sealable against the container 300 to provide a build material input 106 and output 108. In one example, the coupling system 404 provides only a build material input 106.

The coupling system is shown in more detail at 502 in the schematic cross-section shown in FIG. 5. The coupling member 502 provides a build material input 106 and a build material output 108. The coupling member 502 may be coupled to the container build material transport mechanism 208 when in its extended position, as illustrated in FIG. 5. In one example, the coupling member 502 may comprise only a build material input 106, for example for use in the large-scale filling operations of build material containers of the type described herein.

In the example shown, the coupling member 502 comprises a first portion providing a build material input 106 that, when the coupling member 502 is coupled to the build material container 300, is adjacent to the container end wall 304 and forms a seal therewith. The build material input 106 forms a channel, in fluid communication with a portion of the build material transport mechanism 308, into which build material may be provided and which serves to feed, for example under gravity, build material to the build material transport mechanism 308. This allows build material input through the build material input 106 to, when the container is rotated in an appropriate direction, be moved from the build material input 106 inside the container 200 by the build material transport mechanism 308.

The coupling member 502 may additionally comprise a second portion providing a build material output 108 adjacent but mainly separated from the first portion that, when the coupling member 502 is coupled to the build material container 200, is distant from the container end wall 304. The build material output 108 forms a channel generally situated below, and in fluid communication with, the build material transport mechanism 308. This allows, when the container 200 is rotated in an appropriate direction, build material to be moved from the container and into the build material output 108 by the build material transport mechanism 308.

In one example the coupling system 404 comprises a movable coupling member 502 that may be moved over an extended container build material transport mechanism 308 to provide a substantial seal against the openable end 304 of the container 300. In one example the coupling member 502 provides a rotatable sealing feature (not shown) in which the substantial seal provided against the openable end 304 of the container 300 is maintained as the container 300 is rotated. In one example the coupling member 502 may be motorized and controlled by the controller 110 to couple and decouple with a container 300 when such a container is installed into or is removed from the supply station 102.

A method of operating the supply station 102 is described below with additional reference to the flow diagram of FIG. 6.

At block 602, upon a build material container 200 being detected as being present in the supply station 102 the controller 110 controls the container build material transport mechanism extractor system 302 to move the build material transport mechanism 208 into its extended position.

At block 604, the controller 110 controls the container build material transport mechanism coupling system 404 to couple with the extended build material transport mechanism extractor mechanism 308.

At block 606, the controller 110 controls the supply station to transfer build material between the container 200 and build material store (not shown).

If build material is to be transferred from the build material container to an internal storage hopper, the supply station 102 may be controlled to rotate the container in a first direction at a first speed until a desired quantity of build material has been transferred out of the build material container through the supply station output port 108.

If build material is to be transferred from an internal storage hopper to the build material container, the supply station 102 may be controlled to rotate the container in a second direction opposite the first direction at a second speed until a desired quantity of build material has been transferred into the build material container. This may include, for example, providing a flow, or a volume, of build material to the supply station input port 106.

At block 608, the controller 110 controls the container build material transport mechanism coupling system 404 to retract from the extended build material transport mechanism extractor mechanism 308.

At block 610, the controller 110 controls the container build material transport mechanism extractor system 402 to move the build material transport mechanism 308 into its retracted position thereby sealing the container 200.

Referring now to FIG. 7, there is illustrated a post-processing container 700 according to one example. In the example shown the post-processing container 700 is similar the same as the container 300 shown in FIG. 3, with the addition of an openable portion 702 to enable a 3D printed object to be inserted thereinto.

In the example shown in FIG. 7, the openable portion 702 is provided at an end portion of the container 700. In one example the openable portion 702 is removable from the container 700. In one example the openable portion 702 connects to the container 700 via a screw interface. In another example the openable portion 702 connects to the container 700 through a push-fit or other suitable type of interface.

In other examples the container 700 comprises an openable portion 702 that is located other than at an end of the container 700. For example, the openable portion 702 could be located on the curved body of the container 700.

The internal transport elements 314 of the container 700 may cause or augment a tumbling action of a 3D printed object in the container 700 as the container 700 is rotated to perform a post-processing operation.

In one example, the container 700 may be used initially as build material container, and once empty may be used as a post-processing container. In this case, a user may indicate to the supply station the current function of the container. For example, a user may indicate via a user interface whether a particular container is to be used as a build material container or as a post-processing container. In another example, the user may modify an electronic or mechanical identifier on the container to enable the supply station to determine the current use of a container.

Referring now to FIG. 8, there is illustrated a post-processing container 800 according to one example. In one example, the post-processing container 800 has a similar shape to the container 700.

In the example shown in FIG. 8, the openable portion 802 is provided at an end portion of the container 800. In one example the openable portion 802 is removable from the container 800. In one example the openable portion 802 connects to the container 800 via a screw interface. In another example the openable portion 802 connects to the container 800 through a push-fit or other suitable type of interface. In this example, however, the container 800 does not include a build material transport mechanism to enable build material to input or output from the container 800, as illustrated by closed end portion 804.

In one example, as illustrated by dotted line 806, the container 800 may comprise at least one internal feature to assist in post-processing a 3D printed object inserted therein. For example, a container 800 may comprise at least one internal rib, blade, or other element to cause a generally chaotic or unpredictable movement, or tumbling action, of a 3D object in the container 800 as the container 800 is rotated about its central axis at a predetermined speed.

In one example, in addition to inserting a 3D printed object into the container 800 a user may also insert a post-processing media to assist with a post-processing operation. For example, a tumbling media, such as grit, crushed walnut shells, a dye, or 3D printing build material, may be used.

An example of a three-dimensional (3D) printing system 900 comprising a supply station 102 as described herein is illustrated in FIG. 9.

The supply station 102 is to receive a container 200 as described earlier. The controller 110 determines whether the container present in supply station 102 is a build material container or a post-processing container. When a build material container is present in the supply station 102 the controller 110 controls the supply station 102 to transfer build material between the build material container 200 and one of a set of internal build material storage hoppers 902 and 904.

For example, if a build material container full of fresh build material is inserted into the supply station 102, the controller 110 may control the supply station 102 to transfer, via the supply station output port 108, the contents of the build material container 200 to the first, fresh, build material storage hopper 902.

If, for example, an empty build material container is inserted into the supply station 102, the controller 110 may control the supply station to transfer build material from the second build material storage hopper 904 to the empty build material container 200 through the supply station input port 106.

If a post-processing container is inserted into the supply station 102, the controller 110 may control rotation of the container to perform a post-processing operation on a 3D printed object present therein.

The first build material storage hopper 902 may be used for storing fresh, or previously unused, build material. The second build material hopper 904 may be used for storing reclaimed, or recycled, build material as will be described further below.

Build material from the hoppers 902 and 904 may be transported to a delivery hopper 910 using, for example, a pneumatic build material conveyancing system (not shown). The quantity and ratio of build material from each of the hoppers 902 and 904 may be controlled by controllable valves 906 and 908. The delivery hopper 910 is used to form a pile of build material on a platform next to a build chamber, or build unit, 914. The pile of build material may be spread over a build platform of the build chamber to form successive layers of build material 916. Portions of each formed layer 916 of build material may be selectively solidified by a selective solidification module 912 to form a 3D object.

The selective solidification module 912 may selective solidify portions of each layer of build material using any suitable solidification technology. Such technologies may include, for example: selective laser sintering (SLS) technology, fusing agent and fusing energy technology, chemical binder technology, or the like. The selective solidification module may be controlled, for example, by the controller 110, based on a 3D model of a 3D object to be generated.

After completion of a 3D printing process in the build chamber 914, any non-solidified build material may be recovered from the build chamber 914 by a build material reclaim system 918. Such a system may reclaim non-solidified build material, for example, by vibrating the build platform and/or using air flows. Reclaimed build material may be transported, using the pneumatic conveyancing system, to the second build material hopper 904.

Objects generated by the 3D printing system 900 may then be removed from the build chamber 914 and may be inserted into a post-processing container 200. In one example, a user may add a post-processing media into the post-processing container to assist in the post-processing operation. In one example, when the post-processing container 200 is inserted into the supply station 102 the rotation of the post-processing container 200 may be adapted based on knowledge of characteristics of the 3D object or objects therein. For example, if the 3D object(s) has small, fragile features, the controller 110 may cause the supply station to rotate the post-processing container at a slower speed and for a shorter duration than if the 3D object(s) has non-fragile features. The controller 110 may thus determine to rotate the post-processing container 200 according to one or multiple rotation programs. A rotation program may define, for example, a speed or rotation, a duration of rotation, a direction of rotation, or the like. A rotation program may define, for example, multiple or variable rotation speeds, multiple changes of rotation direction, and the like.

In one example, the post-processing rotation program is determined by the controller 110 based on knowledge of the 3D object(s) that were generated in the build chamber 914.

In a further example, the 3D printing system 900 comprises multiple supply stations. In this example, one supply station may be used to supply fresh build material to the first build material storage hopper 902 or to receive recycled build material from the second build material storage hopper 904, and a second supply station may be used to simultaneously rotate a post-processing container to perform a post-processing operation on a 3D object in a post-processing container. In this way, a 3D object generated in a previous 3D printing operation may be post-processed whilst a subsequent 3D printing operation is being performed by the 3D printing system 900.

Overtime, the second build material hopper may become full of reclaimed build material. When this occurs, an empty, or at least partially empty, build material container 200 may be filled with reclaimed build material from the second build material hopper using the method and systems described above. In this way, excess reclaimed build material may be removed from the 3D printing system 500 in a convenient and clean manner for storage or recycling.

It will be appreciated that examples described herein can be realized in the form of hardware, software or a combination of hardware and software. Accordingly, some examples provide a program comprising code for implementing a system or method as claimed herein.

All the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. Apparatus comprising:
a supply station to receive a container; and
a controller to:
determine when a build material container is present in the supply station and to cause the supply station to rotate the build material container to transfer build material between the build material container and a build material store; and
determine when a post-processing container is inserted into the supply station and to cause the post-processing container to rotate to perform a post-processing operation on a three-dimensionally printed object in the post-processing container.

2. The apparatus of claim 1, wherein the processor is to rotate the post-processing container in accordance with a rotation program.

3. The apparatus of claim 1, wherein controller is to rotate the post-processing container to perform a tumbling operation on a 3D object in the post-processing container, the tumbling operation to perform one or more of: a cleaning operation;
and a surface attribute modification operation.

4. The apparatus of claim 2, wherein the apparatus is 3D printer to generate 3D printed objects, and wherein the controller is to determine the rotation program based on characteristics of a 3D object previously generated by the 3D printer.

5. The apparatus of claim 4, wherein the controller is to determine rotation program that comprises one or more of: a direction of rotation; a speed of rotation;
a frequency of change of rotation direction; a duration of rotation.

6. The apparatus of claim 1, wherein the controller is to determine whether a container present in the supply station is a build material container or is a post-processing container.

7. The apparatus of claim 1, wherein the controller is to rotate a build material container in a first direction to transfer build material from the container, via an output port, to a build material storage hopper;

8. The apparatus of claim 1, wherein the controller is to rotate a build material container in a second direction to transfer build material from a build material storage hopper, via an input port, to the build material container.

9. The apparatus of claim 1, further comprising a pair of supply stations, wherein one of the supply stations may be controlled to rotate a build material container to transfer build material between the build material container and to an internal storage hopper whilst a second of the supply stations may be controlled to rotate a post-processing container.

10. A method of operating a 3D printing system supply station, comprising: determining a type of container present in the supply station and, where it is determined that a build material container is present, rotating the build material container to transfer build material between the build material container and a build material storage hopper, and where it is determined that a post-processing container is present, rotating the post-processing container to rotate to perform a post-processing operation on a 3D printed object in the post-processing container.

11. The method of claim 10, wherein rotation of the post-processing container is to perform on a 3D printed object therein one of: a cleaning operation; and a surface attribute modification

12. The method of claim 10, wherein rotation of the post-processing container is performed in accordance with a rotation program that defines one or more of: a rotation direction; a rotation speed; a rotation duration; and a frequency of rotation direction changes.

13. The method of claim 10, wherein determining a type of container comprises one of: reading a container type identifier on the container; and receiving via a user interface a container type.

14. The method of claim 10 further comprising:
rotating a build material container in a first direction to transfer build material out of the build material container; and rotating a build container in a second direction to transfer build material into the build material container.

15. A three-dimensional printer comprising:
a supply station to rotate a container;
a build material storage hopper;
a controller to:
determine when a build material container is present in the supply station and to rotate the build material container to transfer build material between the build material container and the build material storage hopper;
determine when a post-processing container is present in the supply station and to rotate the post-processing container in accordance with a rotation program to perform a post-processing operation on an object in the post-processing container.
